(19) United States
(12) Patent Application Publication
(10) Pub. No.: US 2022/0088788 A1
(43) Pub. Date: Mar. 24, 2022

(54) MOVING BODY, MOVING METHOD

(71) Applicant: SONY GROUP CORPORATION, TOKYO (JP)

(72) Inventors: SEIJI SUZUKI, TOKYO (JP); YOSHIHITO OHKI, KANAGAWA (JP); EMIKA KANEKO, TOKYO (JP); FUMIHIKO IIDA, TOKYO (JP); YURI KUSAKABE, TOKYO (JP); TAKUYA IKEDA, TOKYO (JP)

(21) Appl. No.: 17/310,508

(22) PCT Filed: Jan. 31, 2020
(86) PCT No.: PCT/JP2020/003601

§ 371 Date: Aug. 6, 2021

(30) Foreign Application Priority Data
Feb. 15, 2019 (JP) 2019-025717

(51) Int. Cl. B25J 9/16; G05D 1/02; B25J 5/00; B25J 19/02

(52) U.S. Cl. CPC B25J 9/1697; G05D 1/021; B25J 11/0005; B25J 19/023; B25J 5/007

(57) ABSTRACT

The present technology relates to a moving body and a moving method that make it possible to move the moving body while causing the moving body to exert interactivity. The moving body of one aspect of the present technology moves while controlling a movement speed and a movement direction, depending on a state of the moving body, a state of a person located around the moving body, and a parameter indicating character or emotion of the moving body. The present technology can be applied to movable robots.

### TECHNICAL FIELD

The present technology relates to a moving body and a moving method, and more particularly to a moving body and a moving method capable of moving the moving body while causing the moving body to exert interactivity.

### BACKGROUND ART

There is conventionally a moving body that creates an environment map or the like representing a surrounding situation by sensing surrounding persons and environment, and moves autonomously. Examples of the moving body include an automobile, a robot, and an airplane.

### CITATION LIST

### Patent Document

### Patent Document 1: Japanese Patent Application Laid-Open No. 2013-31897

### Patent Document 2: Japanese Patent Application Laid-Open No. 2013-22705

### Patent Document 3: Japanese Patent Application Laid-Open No. 2012-236244

### SUMMARY OF THE INVENTION

### Problems to be Solved by the Invention

A conventional moving body is limited to a moving body that focuses on supporting movement and activity of persons, such as a moving body as a means of moving persons and a moving body that supports activity of persons such as cleaning.

Moreover, the conventional moving body is limited to a moving body in which information such as emotion and character is given in the robot itself and that acts to give a feeling of familiarity in conjunction with user's action such as stroking the head, like a pet-type robot.

The present technology has been made in view of such a situation, and makes it possible to move a moving body while causing the moving body to exert interactivity.

### Solutions to Problems

A moving body of one aspect of the present technology includes a moving unit that moves while controlling a movement speed and a movement direction, depending on a state of the moving body, a state of a person located around the moving body, and a parameter indicating character or emotion of the moving body.

In one aspect of the present technology, the movement speed and the movement direction are controlled depending on the state of the moving body, the state of the person located around the moving body, and the parameter indicating the character or emotion of the moving body.

### BRIEF DESCRIPTION OF DRAWINGS

FIG. 1 is a diagram illustrating a usage state of a robot system according to an embodiment of the present technology.

FIG. 2 is a diagram illustrating an example of a movement mechanism of a mobile robot.

FIG. 3 is a plan view illustrating a setting example of areas in a room.

FIG. 4 is a diagram illustrating an example of an operation mode of the mobile robot.

FIG. 5 is a diagram illustrating an example of actions in each operation mode.

FIG. 6 is a diagram illustrating an example of parameters that define character of the mobile robot.

FIG. 7 is a diagram illustrating an example of “watching over”.

FIG. 8 is a diagram illustrating an example of “becoming attached”.

FIG. 9 is a diagram illustrating an example of “being vigilant”.

FIG. 10 is a diagram illustrating an example of “reacting to a mark”.

FIG. 11 is a diagram illustrating another example of “reacting to a mark”.

FIG. 12 is a diagram illustrating an example of “being distracted”.

FIG. 13 is a diagram illustrating an example of “gathering together among robots”.

FIG. 14 is a block diagram illustrating a configuration example of the robot system.

FIG. 15 is a block diagram illustrating a functional configuration example of a control unit of a control device.

FIG. 16 is a diagram illustrating an example of recognition of a position of the mobile robot.

FIG. 17 is a diagram illustrating an internal configuration example of a main body unit.

### MODE FOR CARRYING OUT THE INVENTION

<Overview of the Present Technology>

The present technology focuses on changes in character and emotion of a moving body itself, and moves the moving body while causing the moving body to exert interactivity such as interlocking with an action of an object in consideration of a relationship between the object (human, robot, and the like) and the moving body as well as various relationships surrounding the moving body.

Relationships surrounding the moving body include relationships between moving bodies, relationships between moving bodies within a group including a plurality of moving bodies, relationships between groups including a plurality of moving bodies, and the like.

<Application of Robot System>

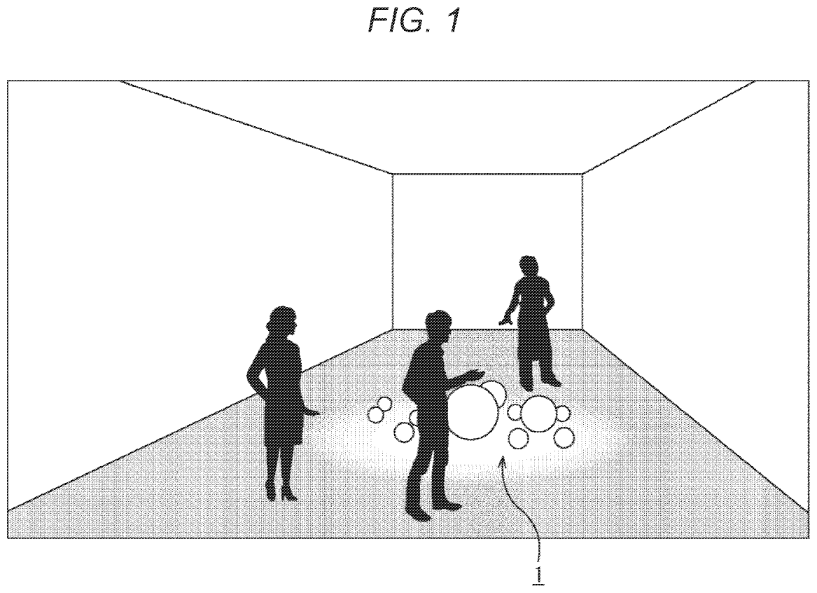

FIG. 1 is a diagram illustrating a usage state of a robot system according to an embodiment of the present technology.

The robot system illustrated in FIG. 1 is used in a space such as a dark room. There are persons in the space where the robot system is installed.

As illustrated in FIG. 1, a plurality of spherical mobile robots 1 is prepared on the floor surface of the room. In the example of FIG. 1, mobile robots 1 of three sizes are prepared. Each mobile robot 1 is a moving body that moves on the floor surface in accordance with control of a control device (not illustrated).

The robot system is provided with a control device that recognizes a position of each mobile robot 1 and a position of each person, and controls movement of each mobile robot 1.

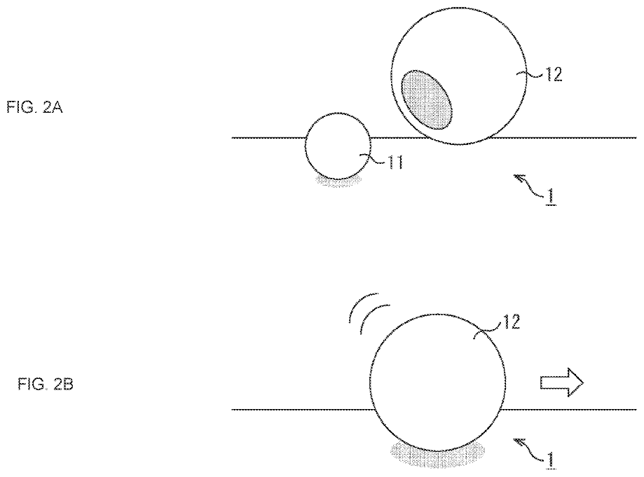

FIG. 2 is a diagram illustrating an example of a mechanism of movement of the mobile robot 1.

As illustrated in A of FIG. 2, each mobile robot 1 includes a spherical main body unit 11 and a hollow cover 12 that is also spherical and covers the main body unit 11.

Inside the main body unit 11, a computer is provided that communicates with the control device and controls actions of the mobile robot 1 in accordance with a control command transmitted from the control device. Furthermore, inside the main body unit 11, a drive unit is also provided that rotates the entire main body unit 11 by changing an amount of rotation and direction of an omni-wheel.

The main body unit 11 rotates with the cover 12 covered, whereby movement of the mobile robot 1 in any direction can be implemented as illustrated in B of FIG. 2.

Each mobile robot 1 illustrated in FIG. 1 has a configuration as illustrated in FIG. 2.

Each mobile robot 1 moves in conjunction with motion of a person. For example, an action of the mobile robot 1 is implemented, such as approaching the person, or moving away from the person in a case where the person is nearby.

Furthermore, each mobile robot 1 moves in conjunction with motion of another mobile robot 1. For example, an action of the mobile robot 1 is implemented, such as approaching another mobile robot 1 being nearby or performing the same motion and dancing.

As described above, each mobile robot 1 moves alone, or moves by forming a group with another mobile robot 1.

The robot system illustrated in FIG. 1 is a system in which a person can communicate with the mobile robot 1 and a community of the mobile robots 1 can be expressed.

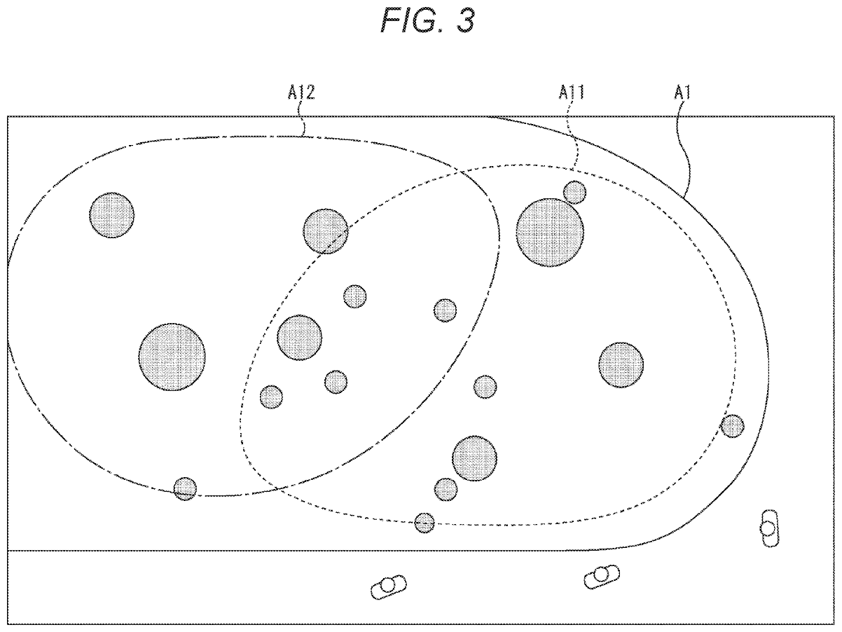

FIG. 3 is a plan view illustrating a setting example of areas in the room.

As illustrated in FIG. 3, a movable area A1 that is an area where the mobile robot 1 can move is set in the room where the robot system is prepared. Lightly colored circles represent the mobile robots 1. In the control device, the position of each mobile robot 1 in the movable area A1 is recognized by using a camera or a sensor provided in the room.

Two areas, an area A11 and an area A12, are set in the movable area A1. For example, the whole of the mobile robots 1 is divided into the mobile robots 1 that move in the area A11 and the mobile robots 1 that move in the area A12.

An area in which each mobile robot 1 moves is set, for example, depending on time, or depending on character of the mobile robot 1 described later.

As a result, it is possible to prevent a situation in which the mobile robots 1 unevenly exist in a part of the movable area A1.

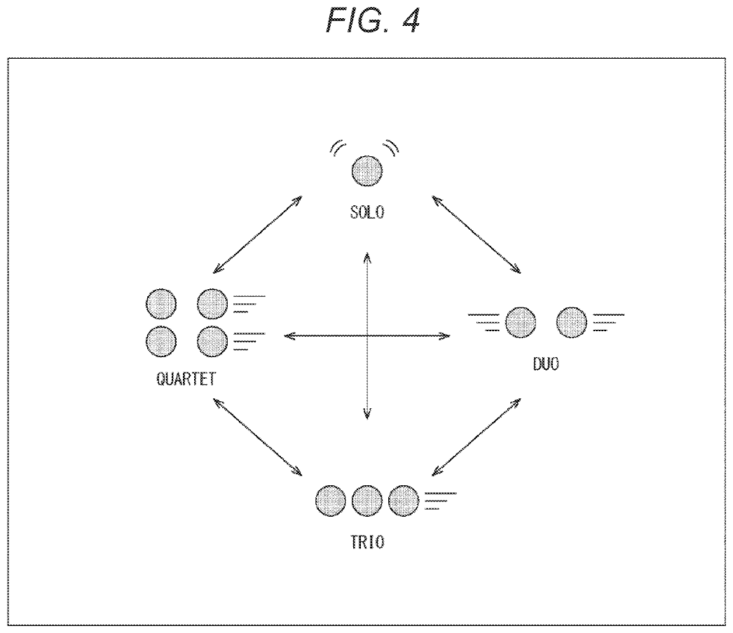

FIG. 4 is a diagram illustrating an example of an operation mode of the mobile robot 1.

As illustrated in FIG. 4, the operation mode of the mobile robot 1 includes a SOLO mode in which a robot operates alone, a DUO mode in which two robots operate in cooperation with each other, a TRIO mode in which three robots operate in cooperation with each other, and a QUARTET mode in which four robots operate in cooperation with each other.

The operation mode of the mobile robot 1 is appropriately switched from a certain operation mode to another operation mode as illustrated by bidirectional arrows. Which operation mode is used is set depending on conditions such as the character of the mobile robot 1, a situation of a person in the room, a situation of another mobile robot 1, and time.

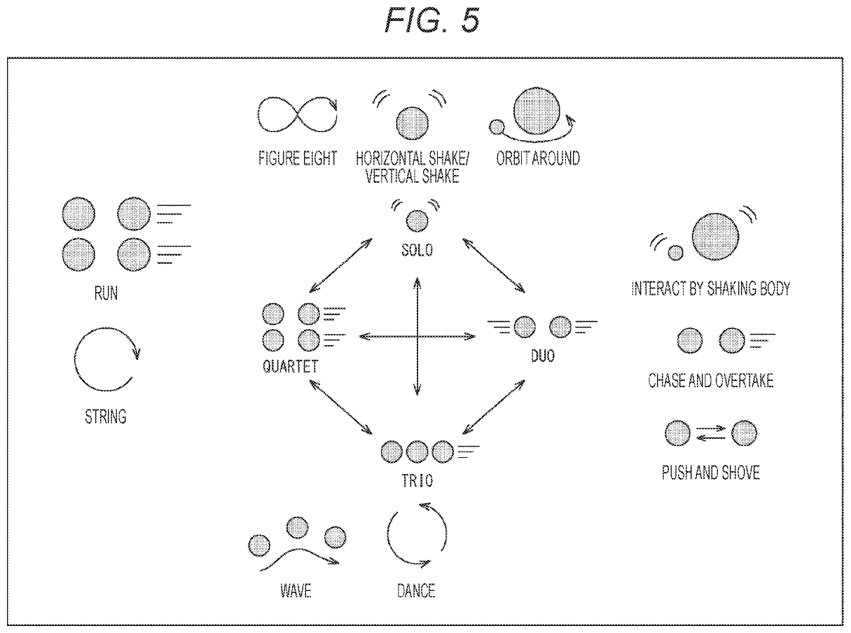

FIG. 5 is a diagram illustrating an example of actions in each operation mode.

As illustrated in FIG. 5, when the SOLO mode is set, the mobile robot 1 takes an action such as moving in a figure eight, shaking on the spot without moving its position, or orbiting around another mobile robot 1.

Furthermore, when the DUO mode is set, the mobile robot 1 takes an action such as shaking together near another mobile robot 1 that forms a group, chasing another mobile robot 1, or pushing against another mobile robot 1.

When the TRIO mode is set, the mobile robot 1 takes an action such as moving following other mobile robots 1 that form a group while gently curving (wave), or moving like drawing a circle with the other mobile robots 1 (dance).

When the QUARTET mode is set, the mobile robot 1 takes an action such as racing with other mobile robots 1 that form a group (run), or moving like drawing a circle with the other mobile robots 1 in a connected state (string).

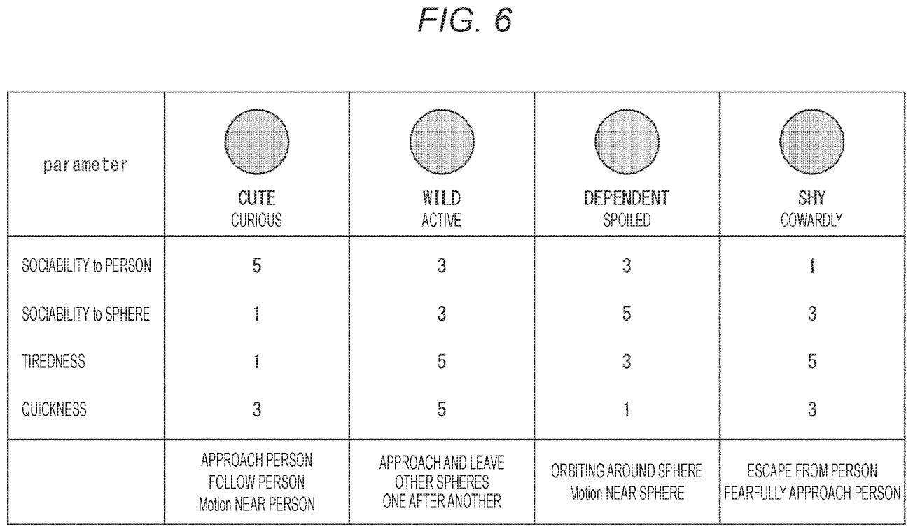

FIG. 6 is a diagram illustrating an example of parameters that define the character of the mobile robot 1.

As the parameters, for example, a parameter representing sociability to persons, a parameter representing sociability to other mobile robots 1, a parameter representing tiredness, and a parameter representing quickness are prepared.

Curious, active, spoiled, and cowardly characters are defined by a combination of values of respective parameters.

The curious (CUTE) character is defined by a combination of 5 for the parameter representing sociability to persons, 1 for the parameter representing sociability to other mobile robots 1, 1 for the parameter of representing tiredness, and 3 for the parameter representing quickness.

The mobile robot 1 having the curious character takes an action, for example, approaching a person, following a person, or taking a predetermined motion near a person.

The active (WILD) character is defined by a combination of 3 for the parameter representing sociability to persons, 3 for the parameter representing sociability to other mobile robots 1, 5 for the parameter of representing tiredness, and 5 for the parameter representing quickness.

The mobile robot 1 having the active character repeatedly performs an action, for example, approaching another mobile robot 1 and then leaving.

The spoiled (DEPENDENT) character is defined by a combination of 3 for the parameter representing sociability to persons, 5 for the parameter representing sociability to other mobile robots 1, 3 for the parameter of representing tiredness, and 1 for the parameter representing quickness.

The mobile robot 1 having the spoiled character takes an action, for example, orbiting around another mobile robot 1 or taking a predetermined motion near the other mobile robot 1.

The cowardly (SHY) character is defined by a combination of 1 for the parameter representing sociability to persons, 3 for the parameter representing sociability to other mobile robots 1, 5 for the parameter of representing tiredness, and 3 for the parameter representing quickness.

The mobile robot 1 having the cowardly character takes an action, for example, escaping from a person or gradually approaching a person.

Such a character is set for each mobile robot 1. Note that, types of the parameters that define the character are not limited to four types illustrated in FIG. 6. Furthermore, the character is not limited to four types.

It can be said that the parameters are information representing not only the character but also the emotion. That is, the parameters are information representing the character or emotion.

<Example of Action of Mobile Robot 1>

Each mobile robot 1 takes various actions on the basis of not only the character and emotion of the mobile robot 1 itself defined by the parameters as described above but also a relationship between the mobile robot 1 and a surrounding situation. The surrounding situation includes an action of a person, character and emotion of a person, an action of another mobile robot 1, and character and emotion of other mobile robot 1.

The actions taken by each mobile robot 1 includes the following.

(1) Watching over

(2) Becoming attached

(3) Being vigilant

(4) Reacting to a mark

(5) Being distracted

(6) Gathering together among robots

(1) Watching Over

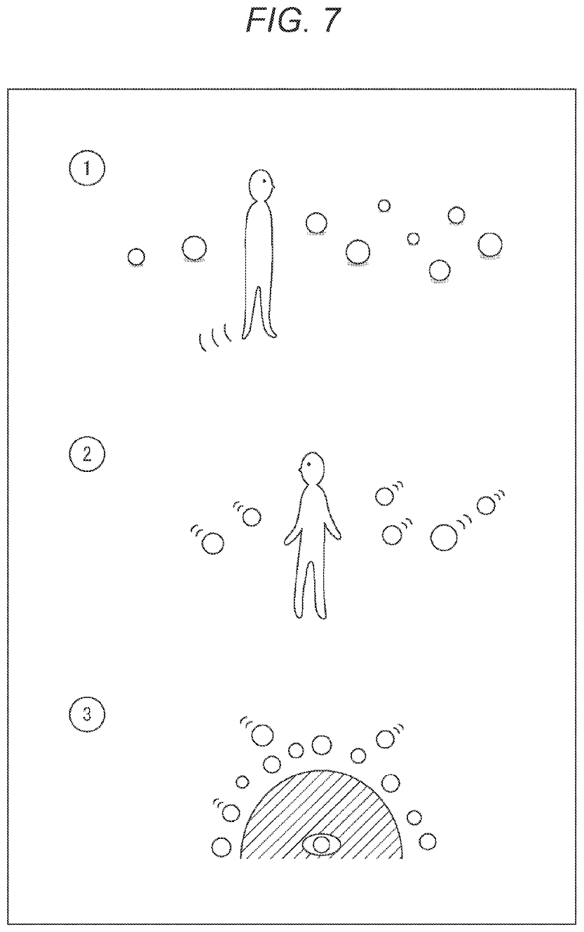

FIG. 7 is a diagram illustrating an example of “watching over”.

As illustrated in FIG. 7, in a case where a person enters the room, the mobile robots 1 being nearby approaches. The mobile robots 1 approaching the person stops on the spot while keeping a certain distance from the person. In a case where a predetermined time elapses, each mobile robot 1 is scattered in any direction.

In this way, an action of “watching over” is implemented.

(2) Becoming Attached

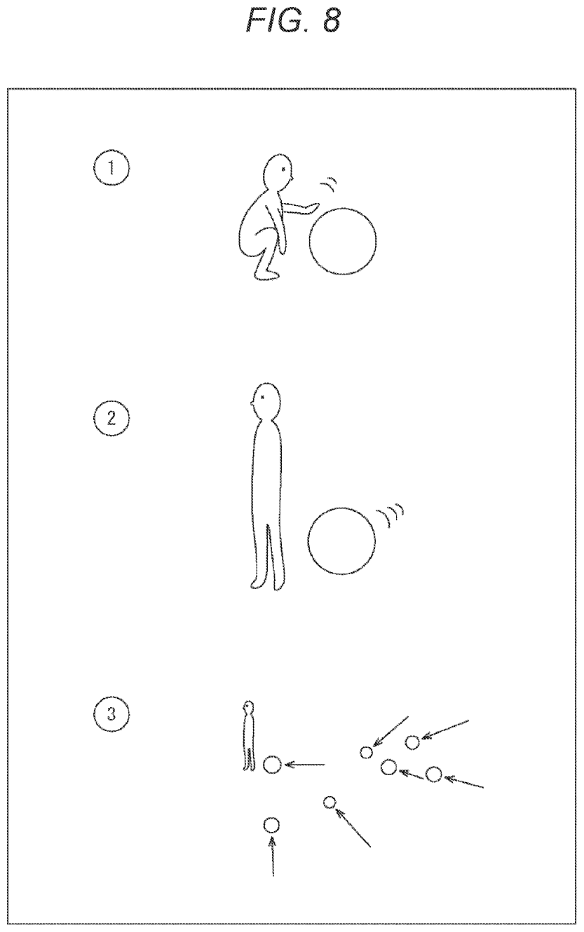

FIG. 8 is a diagram illustrating an example of “becoming attached”.

As illustrated in FIG. 8, in a case where a person crouches and strokes the mobile robot 1, the mobile robot 1 moves to cling to the person. The mobile robot 1 being around also moves following the mobile robot 1 clinging to the person earlier.

In this way, an action of “becoming attached” is implemented.

(3) Being Vigilant

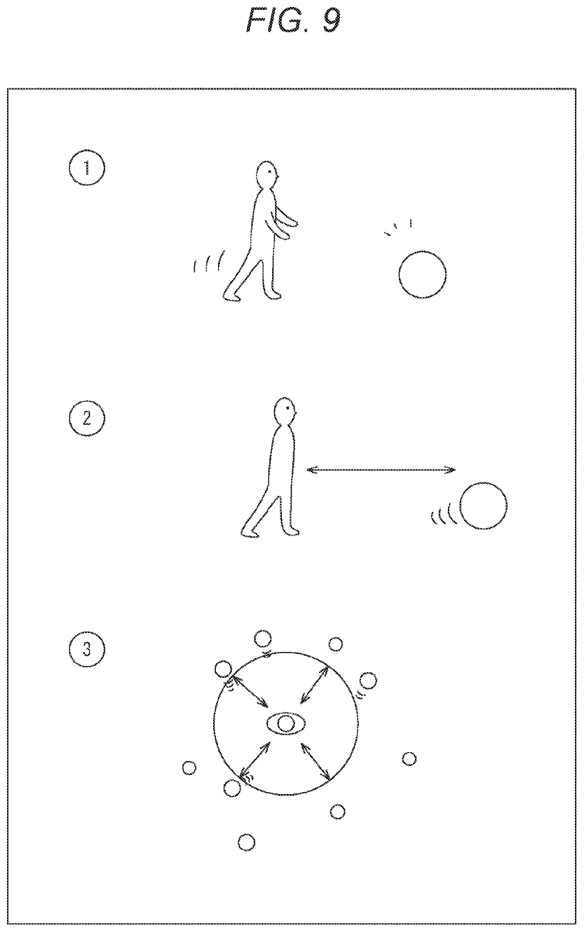

FIG. 9 is a diagram illustrating an example of “being vigilant”.

As illustrated in FIG. 9, in a case where a person approaches at a speed higher than or equal to a predetermined speed, the mobile robot 1 moves in a direction away from the person while keeping a certain distance from the person. Robots being around the person also move to keep a certain distance from the person, whereby an area without the mobile robot 1 is formed within a certain range centered on the person.

In this way, an action of “being vigilant” is implemented.

(4) Reacting to a Mark

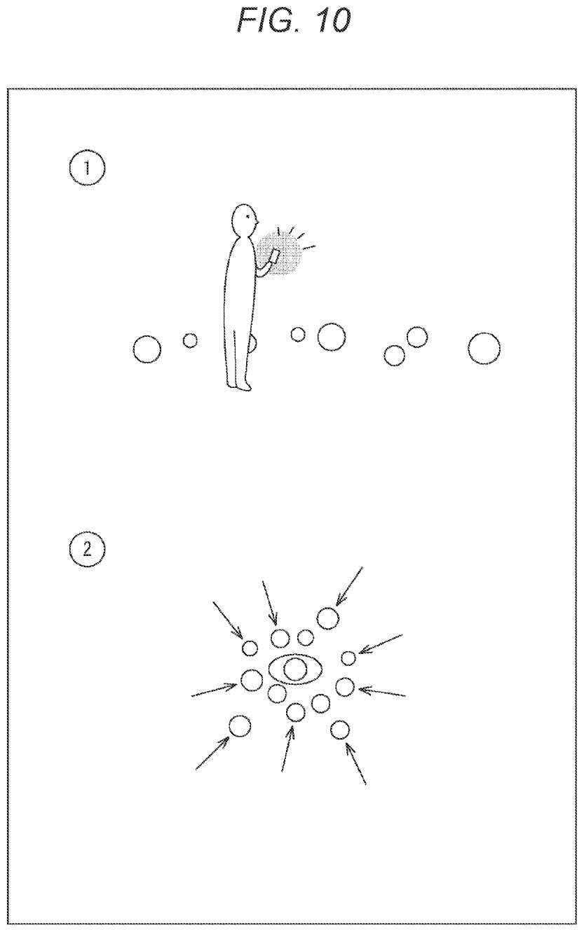

FIG. 10 is a diagram illustrating an example of “reacting to a mark”.

As illustrated in FIG. 10, in a case where a person turns on a display of a smartphone, the mobile robots 1 being around move to flock to the person. A sensor for detecting light of the display is also prepared in the robot system.

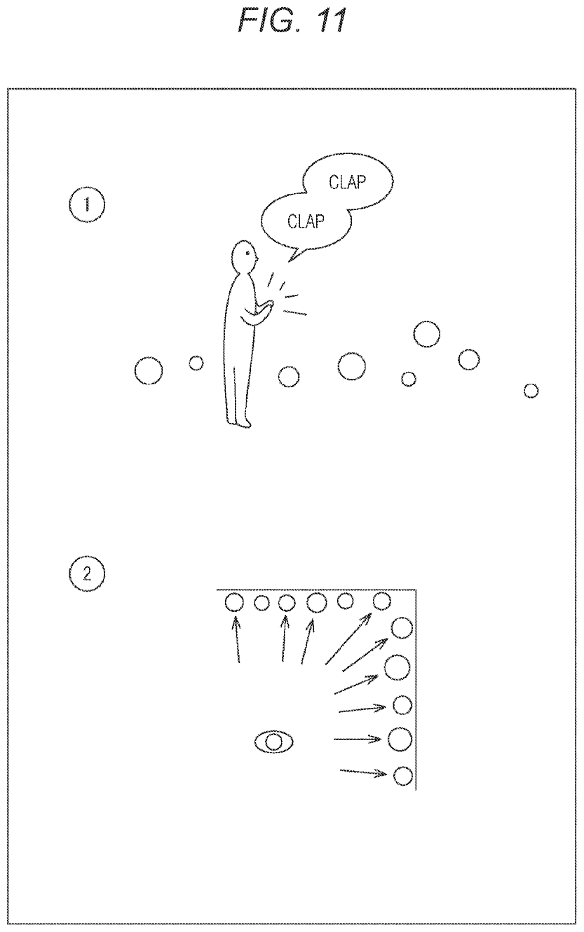

FIG. 11 is a diagram illustrating another example of “reacting to a mark”.

As illustrated in FIG. 11, in a case where a person makes a loud sound by clapping hands or the like, the mobile robot 1 being around moves to wall sides. A microphone for detecting the sound in the room is also prepared in the robot system.

In this way, an action of “reacting to a mark” is implemented.

(5) Being Distracted

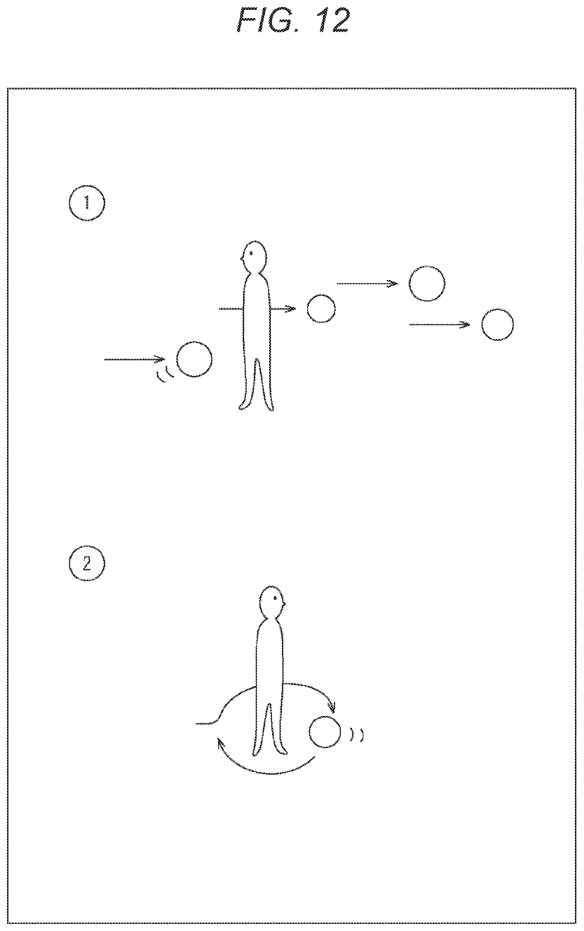

FIG. 12 is a diagram illustrating an example of “being distracted”.

As illustrated in FIG. 12, in a case where the mobile robot 1 collides a person, the mobile robot 1 moves around the person or moves to cling to the person.

In this way, an action of “being distracted” is implemented.

(6) Gathering Together Among Robots

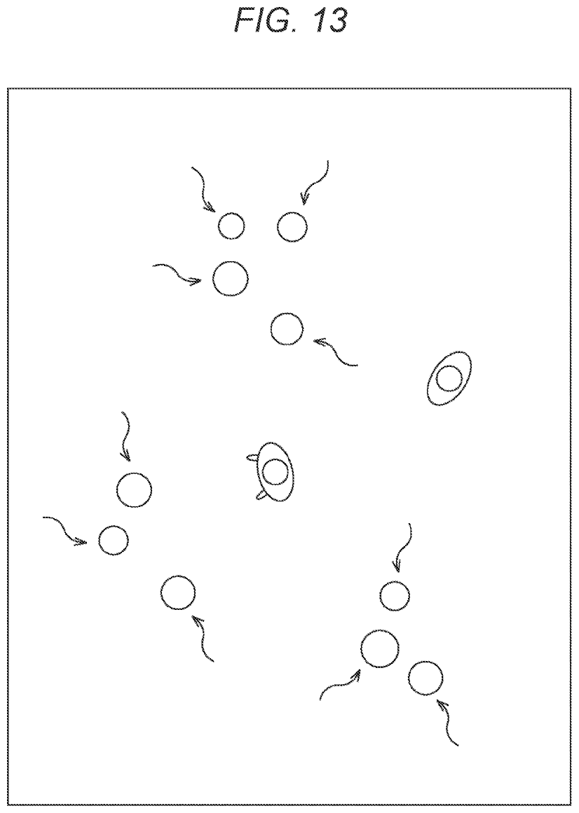

FIG. 13 is a diagram illustrating an example of “gathering together among robots”.

As illustrated in FIG. 13, in a case where a certain timing is reached, all the mobile robots 1 move to form a group of a predetermined number of robots such as three or four robots by gathering together.

In this way, an action of “gathering together among robots” is implemented. The action of “gathering together among robots” such that the mobile robots 1 ignore persons all at once is performed, for example, at predetermined time intervals.

As described above, each mobile robot 1 takes various actions to communicate with a person or to communicate with another mobile robot 1. The robot system can move each mobile robot 1 while causing the mobile robot 1 to exert interactivity with a person or another mobile robot 1.

<Configuration Example of Robot System>

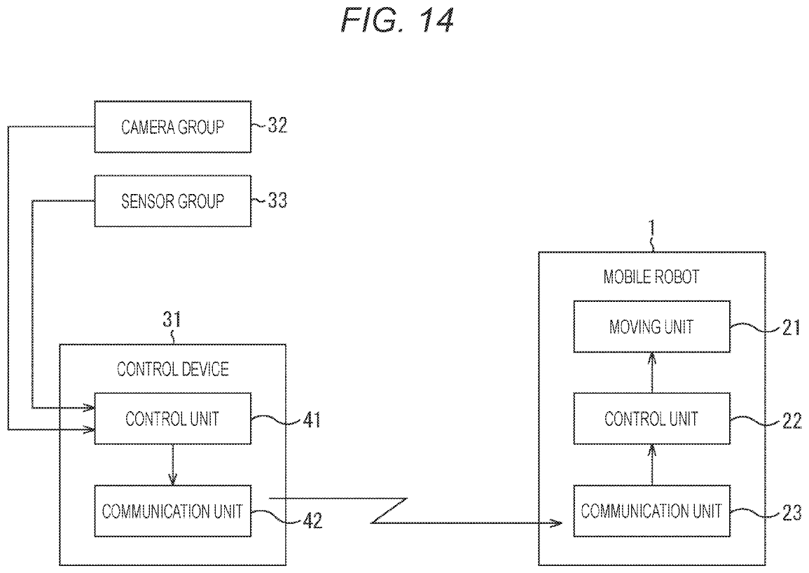

FIG. 14 is a block diagram illustrating a configuration example of the robot system.

As illustrated in FIG. 14, the robot system is provided with a control device 31, a camera group 32, and a sensor group 33 in addition to the mobile robot 1. Cameras constituting the camera group 32 and sensors constituting the sensor group 33 are connected to the control device 31 via wired or wireless communication. The mobile robot 1 and the control device 31 are connected to each other via wireless communication.

The mobile robot 1 includes a moving unit 21, a control unit 22, and a communication unit 23. The moving unit 21, the control unit 22, and the communication unit 23, are provided in the main body unit 11.

The moving unit 21 implements movement of the mobile robot 1 by driving the omni-wheel. The moving unit 21 functions as a moving unit that implements the movement of the mobile robot 1 while controlling the movement speed and the movement direction in accordance with control by the control unit 22. Control of the moving unit 21 is performed in accordance with a control command generated in the control device 31 depending on a state of the mobile robot 1, a state of surrounding persons, and the parameters of the mobile robot 1.

Furthermore, the moving unit 21 also implements an action of the mobile robot 1 such as shaking, by driving a motor, or the like. Details of a configuration of the moving unit 21 will be described later.

The control unit 22 includes a computer. The control unit 22 executes a predetermined program by a CPU and controls the entire operation of the mobile robot 1. The control unit 22 drives the moving unit 21 in accordance with a control command supplied from the communication unit 23.

The communication unit 23 receives a control command transmitted from the control device 31 and outputs the control command to the control unit 22. The communication unit 23 is also provided inside the computer constituting the control unit 22.

The control device 31 includes a data processing device such as a PC. The control device 31 includes a control unit 41 and a communication unit 42.

The control unit 41 generates a control command on the basis of an imaging result by the camera group 32, a detection result by the sensor group 33, and the like, and outputs the control command to the communication unit 42. In the control unit 41, a control command for each mobile robot 1 is generated.

The communication unit 42 transmits a control command supplied from the control unit 41 to the mobile robot 1.

The camera group 32 includes a plurality of cameras arranged at respective positions in the space where the robot system is installed. The camera group 32 may include RGB cameras or IR cameras. Each camera constituting the camera group 32 generates an image for a predetermined range and transmits the image to the control device 31.

The sensor group 33 includes a plurality of sensors arranged at respective positions in the space where the robot system is installed. As the sensors constituting the sensor group 33, for example, a distance sensor, a human sensor, an illuminance sensor, and a microphone are provided. Each sensor constituting the sensor group 33 transmits information representing a sensing result for a predetermined range to the control device 31.

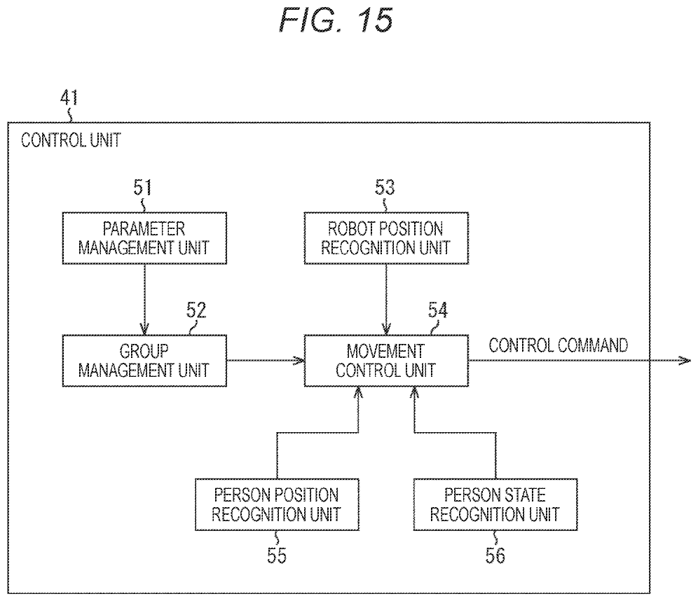

FIG. 15 is a block diagram illustrating a functional configuration example of the control unit 41 of the control device 31.

At least some of functional units illustrated in FIG. 15 are implemented by executing a predetermined program by a CPU of the PC constituting the control device 31.

In the control device 31, a parameter management unit 51, a group management unit 52, a robot position recognition unit 53, a movement control unit 54, a person position recognition unit 55, and a person state recognition unit 56 are implemented.

The parameter management unit 51 manages the parameters of each mobile robot 1 and outputs the parameters to the group management unit 52 as appropriate.

The group management unit 52 sets the operation mode of each mobile robot 1 on the basis of the parameters managed by the parameter management unit 51.

Furthermore, the group management unit 52 forms and manages a group including the mobile robots 1 in which an operation mode other than the SOLO mode is set, on the basis of the parameters and the like of each mobile robot 1. For example, the group management unit 52 forms a group including the mobile robots 1 whose degree of similarity of the parameters is greater than a threshold value.

The group management unit 52 outputs, to the movement control unit 54, information regarding the operation mode of each mobile robot 1 and information regarding the group to which the mobile robot 1 in which the operation mode other than the SOLO mode is set belongs.

The robot position recognition unit 53 recognizes the position of each mobile robot 1 on the basis of the image transmitted from each camera constituting the camera group 32 or on the basis of the sensing result by each sensor constituting the sensor group 33. The robot position recognition unit 53 outputs information representing the position of each mobile robot 1 to the movement control unit 54.

The movement control unit 54 controls movement of each mobile robot 1 on the basis of the information supplied from the group management unit 52 and the position of the mobile robot 1 recognized by the robot position recognition unit 53. The movement of the mobile robot 1 is appropriately controlled also on the basis of the position of the person recognized by the person position recognition unit 55 and the emotion of the person recognized by the person state recognition unit 56.

For example, in the movement control unit 54, in a case where the mobile robot 1 having the curious character acts in the SOLO mode and there is a person within a predetermined distance centered on a current position of the mobile robot 1, a position near the person is set as a destination. The movement control unit 54 generates a control command giving an instruction to move from the current position to the destination.

Furthermore, in the movement control unit 54, in a case where the mobile robot 1 having the active character acts in the DUO mode and a group is formed by one mobile robot 1 and the other mobile robot 1, a destination of each mobile robot 1 is set. The movement control unit 54 generates a control command for each mobile robot 1 giving an instruction to race by moving from the current position to the destination.

The movement control unit 54 generates a control command for each mobile robot 1 and causes the communication unit 42 to transmit the control command. Furthermore, the movement control unit 54 generates a control command for taking each action as described with reference to FIGS. 7 to 13, and causes the communication unit 42 to transmit the control command.

The person position recognition unit 55 recognizes the position of the person on the basis of the image transmitted from each camera constituting the camera group 32 or on the basis of the sensing result by each sensor constituting the sensor group 33. The person position recognition unit 55 outputs information representing the position of the person to the movement control unit 54.

The person state recognition unit 56 recognizes the state of the person on the basis of the image transmitted from each camera constituting the camera group 32 or on the basis of the sensing result by each sensor constituting the sensor group 33.

For example, as the state of the person, an action of the person is recognized such as that a person keeps standing at the same position for a predetermined time or longer, or that a person crouches. Approaching of the mobile robot 1 to a person is started by a predetermined action as a trigger such as, for example, that a person keeps standing at the same position for a predetermined time or longer, or that a person crouches.

Furthermore, the character and emotion of a person are recognized as the state of the person on the basis of a pattern of motion of the person, and the like. For example, in a case where a child who is curious and touches many mobile robots 1 is near a mobile robot 1 having the curious character, control is performed so that the mobile robot 1 is brought closer to the child.

In this case, the mobile robot 1 takes an action of approaching a person whose degree of similarity of the character or emotion is high.

As described above, the action of the mobile robot 1 may be controlled on the basis of the state of the person including the action and emotion. The person state recognition unit 56 outputs information representing a recognition result of the state of the person to the movement control unit 54.

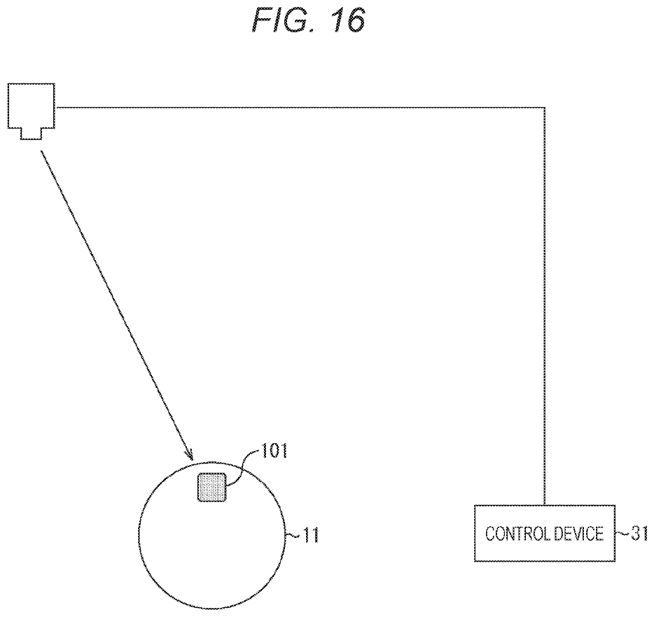

FIG. 16 is a diagram illustrating an example of recognition of the position of the mobile robot 1.

As illustrated in FIG. 16, a light emitting unit 101 that emits IR light is provided inside the main body unit 11 of the mobile robot 1. The cover 12 includes a material that transmits IR light.

The robot position recognition unit 53 of the control device 31 detects a blinking pattern of the IR light of each mobile robot 1 by analyzing images imaged by the IR cameras constituting the camera group 32. The robot position recognition unit 53 identifies the position of each mobile robot 1 on the basis of the detected blinking pattern of the IR light.

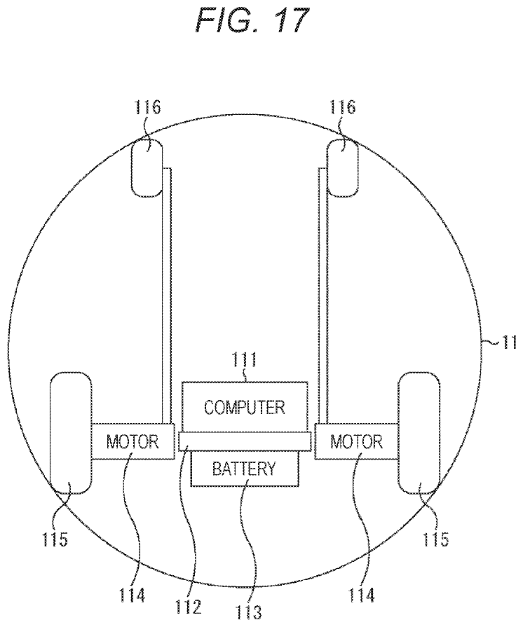

FIG. 17 is a diagram illustrating an internal configuration example of the main body unit 11.

As illustrated in FIG. 17, a computer 111 is provided inside the main body unit 11. A battery 113 is connected to a substrate 112 of the computer 111, and a motor 114 is provided via a driver.

An omni-wheel 115 is attached to the motor 114. In the example of FIG. 17, two each of the motors 114 and the omni-wheels 115 are provided.

The omni-wheel 115 rotates in a state of being in contact with the inner surface of a spherical cover constituting the main body unit 11. By adjusting the amount of rotation of the omni-wheel 115, the entire main body unit 11 rolls, and the movement speed and the movement direction of the mobile robot 1 are controlled.

A guide roller 116 is provided at a predetermined position on the substrate 112 via a support member. The guide roller 116 is pressed against the inner surface of the cover of the main body unit 11 by, for example, a spring material serving as a support column. As the omni-wheel 115 rotates, the guide roller 116 also rotates in a state of being in contact with the inner surface of the cover.

Instead of covering the main body unit 11 having the configuration illustrated in FIG. 17 with the cover 12, the configuration illustrated in FIG. 17 may be provided directly inside the cover 12.

<Example of Control by Movement Control Unit 54>

The control by the movement control unit 54 is performed depending on the state of the mobile robot 1, the state of the person being around the mobile robot 1, and the parameters indicating the character and emotion of the mobile robot 1.

As described above, the state of the person also includes the character and emotion of the person recognized by the person state recognition unit 56 on the basis of the action of the person and the like. In this case, the control by the movement control unit 54 is performed depending on a combination of the character and emotion of the mobile robot 1 represented by the parameters and the character and emotion of the person.

In a case where a degree of similarity between the character and emotion of the mobile robot 1 represented by the parameters and the character and emotion of the person is higher than or equal to a threshold value, control may be performed to bring the mobile robot 1 closer to the person. In this case, the mobile robot 1 moves to a person whose character and emotion are similar to those of the mobile robot 1.

In a case where the degree of similarity between the character and emotion of the mobile robot 1 represented by the parameters and the character and emotion of the person is smaller than the threshold value, control may be performed to bring the mobile robot 1 away from the person. In this case, the mobile robot 1 moves away from a person whose character and emotions are not similar to those of the mobile robot 1.

Furthermore, the control by the movement control unit 54 is performed so that the mobile robots 1 form a group depending on a combination of the state of the mobile robot 1 and a state of another mobile robot 1.

For example, the group is formed by the mobile robots 1 being nearby. Furthermore, the group is formed by the mobile robots 1 whose degree of similarity of the parameters is higher than the threshold value and whose character and emotion are similar.

The mobile robot 1 belonging to a predetermined group moves while being in a state of forming the group together with another mobile robot 1.

While being in the state of forming the group, an action such as approaching or leaving a person is performed on a group basis. In this case, the action of a certain mobile robot 1 is controlled on the basis of three parameters, the state of the person, the state of the mobile robot 1 itself, and a state of another mobile robot 1 belonging to the same group.

One mobile robot 1 out of the mobile robots 1 belonging to a certain group may be set as a master robot. In this case, another mobile robot 1 belonging to the same group is set as the master robot.

For a group in which the master robot is set, the parameters of the master robot are set as representative parameters representing the character and emotion of the entire group. The action of each mobile robot 1 belonging to the group is controlled in accordance with the representative parameters.

<Modifications>

It has been described that the action of the mobile robot 1 is controlled by the control device 31; however, the mobile robot 1 may estimate a self-position and move autonomously while determining the surrounding situation.

It has been described that the mobile robot 1 takes an action in conjunction with the action of a person or in conjunction with the action of another mobile robot 1; however, the mobile robot 1 may take the actions described above in conjunction with an action of another type of robot such as a pet-type robot.

A series of processing steps described above can be executed by hardware, or can be executed by software. In a case where the series of the processing steps is executed by the software, a program configuring the software is installed from a program recording medium to a computer incorporated in dedicated hardware, a general purpose personal computer, or the like.

The program executed by the computer can be a program by which the processing is performed in time series along the order described in the present specification, and can be a program by which the processing is performed in parallel or at necessary timing such as when a call is performed.

In the present specification, a system means an aggregation of a plurality of constituents (device, module (component), and the like), and it does not matter whether or not all of the constituents are in the same cabinet. Thus, a plurality of devices that is accommodated in a separate cabinet and connected to each other via a network and one device that accommodates a plurality of modules in one cabinet are both systems.

Note that, the advantageous effects described in this specification are merely examples, and the advantageous effects of the present technology are not limited to them and may include other effects.

The embodiment of the present technology is not limited to the embodiments described above, and various modifications are possible without departing from the gist of the present technology.

For example, the present technology can adopt a configuration of cloud computing that shares one function in a plurality of devices via a network to process in cooperation.

### REFERENCE SIGNS LIST

1 Mobile robot
31 Control device
32 Camera group
33 Sensor group

1. A moving body comprising
a moving unit that moves while controlling a movement speed and a movement direction, depending on a state of the moving body, a state of a person located around the moving body, and a parameter indicating character or emotion of the moving body.

2. The moving body according to claim 1, wherein
the state of the person is character or emotion of the person, and
the moving unit moves while controlling the movement speed and the movement direction, depending on a combination of the character or the emotion of the person and the parameter.

3. The moving body according to claim 2, wherein
the moving unit moves while controlling the movement speed and the movement direction to approach the person in a case where a degree of similarity between the character or the emotion of the person and the parameter is greater than or equal to a threshold value.

4. The moving body according to claim 2, wherein
the moving unit moves while controlling the movement speed and the movement direction to move away from the person in a case where a degree of similarity between the character or the emotion of the person and the parameter is smaller than a threshold value.

5. The moving body according to claim 1, wherein
the state of the person is motion of the person, and
the moving unit moves while controlling the movement speed and the movement direction, following the motion of the person.

6. The moving body according to claim 1, wherein
the moving unit moves in a state of forming a group with another moving body, depending on a combination of the state of the moving body and a state of the other moving body.

7. The moving body according to claim 6, wherein
the moving unit moves in a state of forming the group together with the other moving body having a degree of similarity of the parameter higher than a threshold value.

8. The moving body according to claim 6, wherein
the moving unit moves while controlling the movement speed and the movement direction by using the parameter of a master moving body that leads movement of the group as a representative parameter indicating character or emotion of the group.

9. The moving body according to claim 1, wherein
the moving unit moves while controlling the movement speed and the movement direction within a movement range set for each moving body.

10. The moving body according to claim 6, wherein
the other moving body is a robot, and
the moving unit moves while controlling the movement speed and the movement direction, depending on a combination of the parameter of the moving body itself and a parameter indicating character or emotion of the robot.

11. The moving body according to claim 10, wherein
the moving unit moves while controlling the movement speed and the movement direction to follow the robot in a case where a degree of similarity between the parameter of the moving body itself and the parameter of the robot is greater than or equal to a threshold value.

12. The moving body according to claim 1, wherein
the moving body is covered with a spherical cover, and
the moving unit rotates the cover by rotating a wheel and causing movement.

13. The moving body according to claim 12, wherein
the moving unit changes a rotation direction of the cover by changing a direction of the wheel and causing movement.

14. The moving body according to claim 13, wherein
the moving unit further includes a guide roller that rotates while being in contact with the cover by rotating with a spring material as a support column.

15. The moving body according to claim 14, further comprising
a light emitting body that emits infrared rays, wherein
the moving body is identified by detection of a blinking pattern of the infrared rays emitted from the light emitting body.

16. A moving method in which
a moving body
moves while controlling a movement speed and a movement direction, depending on a state of the moving body, a state of a person located around the moving body, and a parameter indicating character or emotion of the moving body.
